(19) United States
(12) Patent Application Publication
(10) Pub. No.: US 2010/0001836 A1
(43) Pub. Date: Jan. 7, 2010

(54) Method of Determining the Position of a Transponder in Relation to a Communicator

(75) Inventor: Mikael Willgert, Spanga (SE)

Correspondence Address: YOUNG & THOMPSON, 209 Madison Street, Suite 500, Alexandria, VA, 22314, US

(73) Assignee: Tagmaster AB, Kista (SE)

(21) Appl. No.: 11/794,477

(22) PCT Filed: Dec. 6, 2005
(86) PCT No.: PCT/SE05/01843

§ 371 Date: Jul. 13, 2007

(30) Foreign Application Priority Data
Dec. 30, 2004 (SE) 0403200-9

(51) Int. Cl. G06K 7/01

(52) U.S. Cl. 340/10.1

(57) ABSTRACT

A method of determining the position of a transponder in relation to a communicator, wherein the transponder (9) can be read by a communicator (11) which is adapted to send an inquiry signal to the transponder, wherein the transponder (9) is adapted to answer the inquiry signal and therewith transfer information from a memory in the transponder and wherein the communicator (11) is connected to a principal data system (16) and is adapted to receive the information. The method is characterized by connecting the communicator (11) to an envelope detector (15) which is caused to detect the envelope of the signal received from the transponder (9); and by determining the relative position between the transponder (9) and the communicator (11) from the envelope.

The present invention relates to a method of determining a position of a transponder in relation to a communicator.

Known automatic identification systems normally include person-carried identification tags and equipment for reading the tags.

Known automatic identification systems that use radio frequencies, so-called RFID (Radio Frequency Identification), include at least one transponder and at least one communicator. A known type of transponder includes an antenna, a modulator, a memory and a modulator controlling logic circuit. This known transponder is designed to receive a signal sent by the communicator and reflect this signal in a modulate state. The communicator is designed to receive and read the modulated signal reflected by the transponder.

The system also includes ID-tags for sending information to a communicator.

One area of use of such a system resides in a train position determining system, which is used in regard of braking the speed of the train and therewith controlling its stop position, for instance relative to a railway platform. A desired accuracy with respect to this stop position is +/−5-10 cm.

In this respect, a train is provided with a communicator and transponders are placed along the railroad track.

One problem with this known system is that the positions at which the transponders are read is, among other things, dependent on the antenna lobes of the transponder and the communicator, and the distance between these antennas. With regard to positioning, the detected position between the transponder and the communicator concerned is influenced when reading of the transponder takes place at an early stage or at a late stage in the time slot in which reading is possible.

This problem is solved by means of the present invention.

The present invention relates to a method of determining the position of a transponder in relation to a communicator, wherein the transponder can be read by means of a communicator which is adapted to send an inquiry signal to the transponder, wherein the transponder is adapted to answer the inquiry signal, and therewith transfer information from a memory in the transponder, and wherein the communicator is connected to a principal data system, and is adapted to receive said information and wherein the method is characterized by connecting the communicator to an envelope detector which is caused to detect the envelope of the signal received from the transponder, and by causing the relative position between the transponder and the communicator to be determined from said envelope.

The invention will now be described in more detail partly with reference to an exemplifying embodiment of the invention illustrated in the accompanying drawing, of which

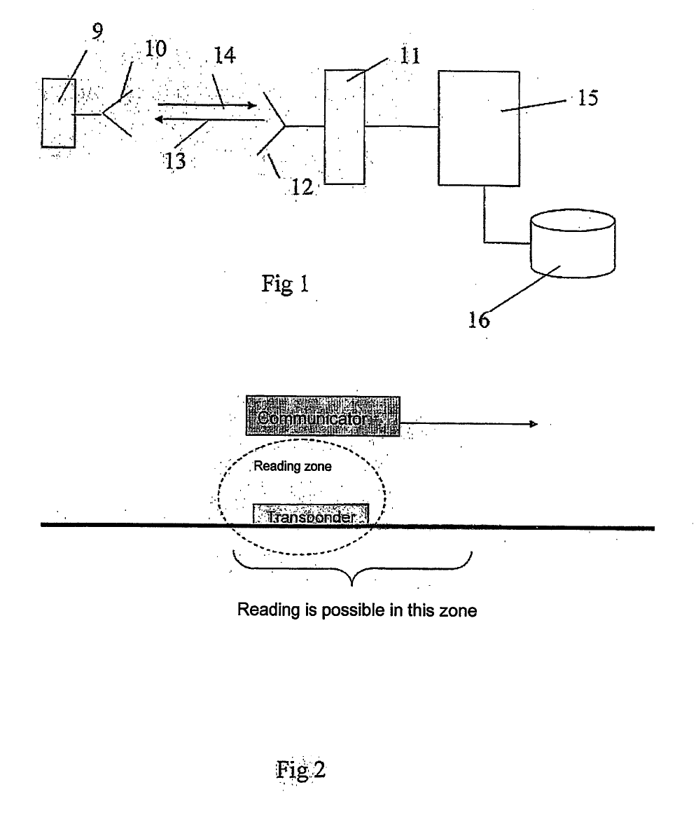

FIG. 1 is a diagrammatic illustration of a transponder and a communicator;

FIG. 2 illustrates a communicator that has moved along a railroad track, said figure illustrating the position at which the first reading takes place at a varying instance, and wherein the figure illustrates the signal that is received in a communicator that moves along a railroad track relative to a transponder, where parameters such as distance above the track, speed, etc., vary;

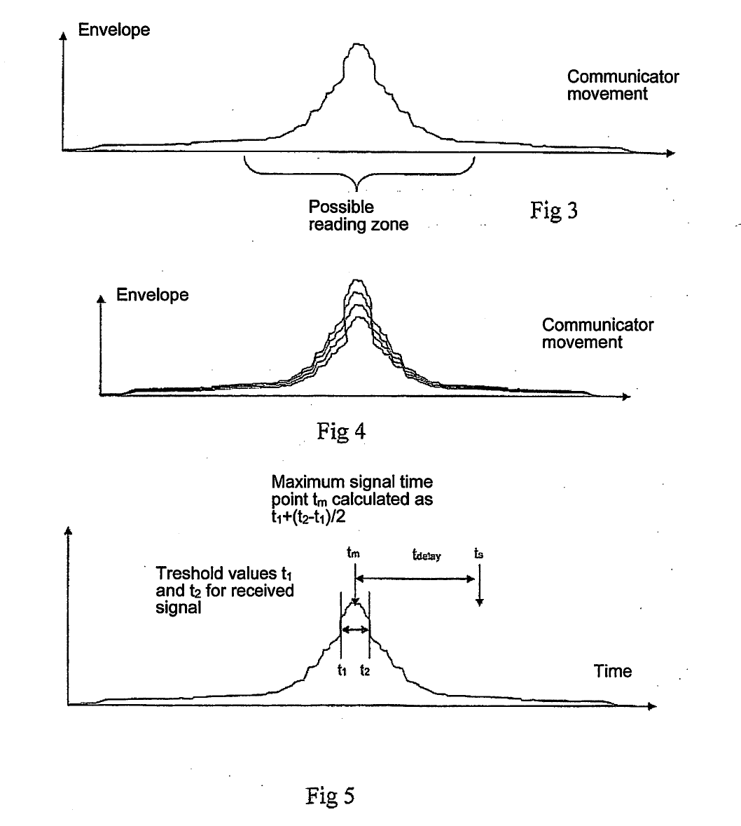

FIG. 3 illustrates the principle appearance of the envelope of a received signal as the communicator passes a transponder;

FIG. 4 shows the principle appearance of the envelope of a received signal, dependent on the height above the track, damping caused by water and snow etc.; and

FIG. 5 illustrates an example of how the time point relating to passage of a reference point can be achieved.

FIG. 1 illustrates a system for identifying objects or people. The system comprises a transponder 9, which includes an antenna 10, and a communicator in the form of a transceiver unit 11, which includes an antenna 12. The communicator 11 is designed to send an inquiry signal 13 to the transponder 9. The transponder is designed to receive the inquiry signal and therewith reflect and modulate said signal. The communicator 11 is designed to receive the reflected signal 14 and to decode the information content of the signal. The communicator 11 is connected to a principal data system 16 of some appropriate kind, such as a cable, radio, W-Lan, GSM/GPRS/G3 system or some like system.

The transponder 9 may, instead, be of a type where the transponder receives the inquiry signal 13 and then actively sends a response signal 14 back to the communicator 11 with a built-in transmitter.

The invention thus relates to a method of determining the position of a transponder in relation to a communicator.

The communicator 11 is designed to receive this information and is connected to a principal or super ordinate data system 16. Naturally, many transponders may be placed along a track or passageway. The principal data system is designed to control, for instance, railroad traffic, the stopping positions of trains at respective stations, to control unmanned trains, to calculate initiation of a braking or slow-down sequence, etc., and to forward such information to the trainset and to the station equipment.

According to the present invention, the communicator 11 is connected to an envelope detector 15 which is caused to detect the envelope of the signal received from the transponder 9, wherewith the relative position between the transponder 9 and the communicator 11 is determined from said envelope.

In one highly preferred embodiment of the invention, there is determined a maximum value of the envelope or a value above a pre-determined envelope threshold value. The relative position between the transponder and the communicator at said pre-determined envelope value is also determined.

FIG. 3 shows the principle appearance of the envelope of a received signal as the communicator passes a transponder.

As the communicator approaches the transponder, damping of the transferred signal decreases in relation to the shorter distance. Damping of the reflected signal also decreases, meaning that the strength of the signal will increase rapidly as the communicator comes closer to the transponder and then decreases strongly subsequent to passing the transponder. This characteristic is amplified by the shape of the antenna lobes.

FIG. 4 illustrates an example of the appearance of the envelope of a received signal, depending on the height above the track, damping caused by water and snow, etc.

According to one preferred embodiment there is determined the time point of a first threshold value as the envelope rises and the time point of a second threshold value as the envelope drops after having passed said maximum, wherein the time point of said maximum is calculated to have occurred at a time point midway of said two time points.

The envelope detector 15 is thus designed to determine the time point at which the amplitude of the received signal is at its maximum. The physical point corresponding to this time point can be calculated from the physical position of the transponder.

The first and the second time points are determined by sampling the received signal and thereafter determine the time point of the maximum amplitude from the formula tm=t1+(t2−t1)/2, where t1 is the first time point and t2 is the second time point

Although said parameters may vary on different occasions, it has been found that the maximum of the envelope is situated at the same physical positions along the track to a high degree of accuracy.

The reference point sought may also be calculated as the centre-of-gravity of the envelope or by some other mathematical process of the envelope that is deemed beneficial with respect to the configuration and mutual angle of the antennas.

This enables the position of the communicator relative to the position of the transponder to be read to a high degree of accuracy.

For example, when the invention is applied with respect to a train, the principal data system is provided with information concerning the trainset that shall stop at a railroad platform for instance. This information can be utilised to cause the train to stop at a platform at a position that, for instance, depends on the number of carriages in the trainset.

According to a preferred embodiment of the invention, in the event of a delay from the time point of the envelope maximum to the time at which a signal to this effect reaches the principal data system, the principal data system is caused to subtract this time delay when calculating the physical position at which said maximum is measured.

The present invention, however, can be used in all manner of applications, particularly in applications where both identification and accurate positioning are concerned.

The invention thus solves the problem mentioned in the introduction.

Although the invention has been described with reference to a number of exemplifying embodiments, it will be understood that the detailed design of the electronic components included may be varied. For example, the envelope detector may be integrated with the communicator, or with the principal data system.

Consequently, the present invention shall not be considered to be limited by the disclosed embodiments, since these embodiments may be varied within the scope of the accompanying claims.

1-4. (canceled)

5. A method of determining the position of a transponder in relation to a communicator, wherein the transponder (9) can be read by means of a communicator (11) which is adapted to send an inquiry signal to the transponder, wherein the transponder (9) is adapted to answer the inquiry signal and therewith transfer information from a memory in the transponder and wherein the communicator (11) is connected to a principal data system (16) and is adapted to receive said information, where the communicator (11) is arranged at a vehicle and where the transponder (9) is arranged at a way for, or a path for, transportation for the vehicle and wherein the communicator is connected to an envelope detector (15), which is caused to detect the envelope of the signal received by the transponder (9) and wherein the method is characterized by causing the relative position between the transponder (9) and the communicator (11) to be determined from said envelope with an accuracy of less than +/−10 cm by determining the maximum of the envelope or a value above a predetermined threshold value for the envelope or a function of the envelope, and by determining the relative position between the transponder (9) and the communicator (11) at said pre-determined value of said envelope.

6. A method according to claim 5, characterized by determining a time point (t1) for a first threshold value as the envelope rises and the time point (t2) of a second threshold as the envelope falls after having passed said maximum; and by calculating that the time point™ of said maximum will have occurred midway between said two time points (t1, t2).

7. A method according to claim 5, wherein in the event of a delay from the time(tm) of the envelope maximum is detected and a signal to this effect reaches the principal data system, the principal data system (16) is caused to subtract this delay when calculating the physical position when said maximum is measured.

8. A method according to claim 6, wherein in the event of a delay from the time(tm) of the envelope maximum is detected and a signal to this effect reaches the principal data system, the principal data system (16) is caused to subtract this delay when calculating the physical position when said maximum is measured.
